(19) United States
(12) Patent Application Publication
(10) Pub. No.: US 2025/0013354 A1
(43) Pub. Date: Jan. 9, 2025

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Zikai QI, Beijing (CN); Shi CHEN, Beijing (CN); Xiao XU, Beijing (CN); Ying XU, Beijing (CN); Yifan DING, Beijing (CN); Dapeng CAO, Beijing (CN); Yu DENG, Beijing (CN); Kuo PEI, Beijing (CN); Yangyang XIANG, Beijing (CN); Jieke LIN, Beijing (CN)

(21) Appl. No.: 18/711,070

(22) PCT Filed: Nov. 14, 2022
(86) PCT No.: PCT/CN2022/131731

§ 371 Date: May 16, 2024

(30) Foreign Application Priority Data
Nov. 17, 2021 (CN) 202111364886.4

(51) Int. Cl. G06F 3/0484

(52) U.S. Cl. CPC G06F 3/0484

(57) ABSTRACT

The present disclosure provides an information processing method and apparatus, an electronic device, and a storage medium. The present disclosure provides an information processing method. The method includes: receiving a first document, so as to perform preset processing on the first document; determining, based on document content of the first document, or the document content and associated information of the first document, whether there is an alert item in the first document that satisfies a preset condition; and displaying the first document in association with the alert item in response to there being the alert item in the first document, where the alert item is displayed in association with category information.

### CROSS-REFERENCE TO RELATED APPLICATIONS

The present application is based on and claims priority to Chinese Patent Application No. 202111364886.4, filed on Nov. 17, 2021, and entitled “INFORMATION PROCESSING METHOD AND APPARATUS, ELECTRONIC DEVICE, AND STORAGE MEDIUM”, which is incorporated herein by reference in its entirety.

### TECHNICAL FIELD

The present disclosure relates to the field of computer technologies, and in particular, to an information processing method and apparatus, an electronic device, and a storage medium.

### BACKGROUND ART

When processing a document in office hours or on a daily basis, for example, when processing contract text, it is necessary to review document content of the document, to prevent potential risks in the document or to pay sufficient attention to other important items. At present, there is a lack of corresponding tools to assist users in completing the above processing.

### SUMMARY OF THE INVENTION

The present disclosure provides an information processing method and apparatus, an electronic device, and a storage medium.

The following technical solutions are used in the present disclosure.

In some embodiments, the present disclosure provides an information processing method, the method including:
receiving a first document, so as to perform preset processing on the first document;
determining, based on document content of the first document, or the document content and associated information of the first document, whether there is an alert item in the first document that satisfies a preset condition; and
displaying the first document in association with the alert item in response to there being the alert item in the first document, where the alert item is displayed in association with category information. In some embodiments, the present disclosure provides an information processing apparatus, the apparatus including:
a receiving unit configured to receive a first document, so as to perform preset processing on the first document;
a determination unit configured to determine, based on document content of the first document, or the document content and associated information of the first document, whether there is an alert item in the first document that satisfies a preset condition; and a display unit configured to display the first document in association with the alert item in response to there being the alert item in the first document, where the alert item is displayed in association with category information.

In some embodiments, the present disclosure provides an electronic device, the electronic device including: at least one memory and at least one processor, where the memory is configured to store program code, and the processor is configured to call the program code stored in the memory to perform the method described above.

In some embodiments, the present disclosure provides a computer-readable storage medium configured to store program code that, when executed by a processor, causes the processor to perform the method described above.

The information processing method provided in the embodiment of the present disclosure includes: receiving a first document, so as to perform preset processing on the first document; determining, based on document content of the first document, or the document content and associated information of the first document, whether there is an alert item in the first document that satisfies a preset condition; and displaying the first document in association with the alert item in response to there being the alert item in the first document, where the alert item is displayed in association with category information. According to the method provided in embodiments of the present disclosure, the alert item in the first document is identified and displayed in association with the first document, and the category information of the alert item is displayed, to effectively enable users to pay attention to important content in the first document, thereby ensuring security and improving efficiency.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an information processing method according to an embodiment of the present disclosure;

FIG. 2 is a schematic diagram of a display interface according to an embodiment of the present disclosure;

FIG. 3 is a schematic diagram of a display interface according to an embodiment of the present disclosure;

FIG. 4 is a schematic diagram of a display interface according to an embodiment of the present disclosure;

FIG. 5 is a schematic diagram of a display interface according to an embodiment of the present disclosure;

FIG. 6 is a schematic diagram of a display interface according to an embodiment of the present disclosure;

FIG. 7 is a schematic diagram of a display interface according to an embodiment of the present disclosure;

FIG. 8 is a schematic diagram of a display interface according to an embodiment of the present disclosure;

FIG. 9 is a schematic diagram of a display interface according to an embodiment of the present disclosure;

FIG. 10 is a schematic diagram of a display interface according to an embodiment of the present disclosure;

FIG. 11 is a schematic diagram of a display interface according to an embodiment of the present disclosure;

FIG. 12 is a schematic diagram of a display interface according to an embodiment of the present disclosure;

FIG. 13 is a schematic diagram of a structure of an electronic device according to an embodiment of the present disclosure.

### DETAILED DESCRIPTION OF THE INVENTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifier “one” mentioned in the present disclosure is illustrative and not restrictive, and those skilled in the art should understand that unless the context clearly indicates otherwise, the modifier should be understood as “one or more”.

The names of messages or information exchanged between a plurality of apparatuses in the implementations of the present disclosure are used for illustrative purposes only, and are not used to limit the scope of these messages or information.

The solutions provided in the embodiments of the present disclosure are described in detail below with reference to the accompanying drawings.

In a document processing scenario, processing of a document is required on some occasions. In some cases, there may be an alert item in the document. For example, there may be a risk item that poses a risk and content that requires attention. The alert item is important content. A user needs to pay special attention to the alert item during document processing. An error indicated by the alert item is likely to cause great loss to the user, and thus requires special attention during document processing. In some embodiments of the present disclosure, the alert item in the document is identified and displayed to enable the user to avoid risks, thereby ensuring the security of the document.

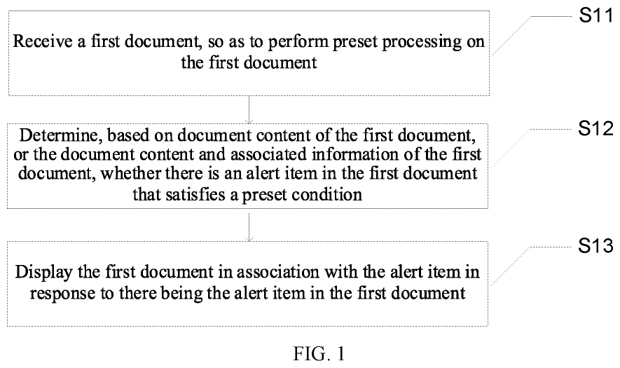

As shown in FIG. 1, FIG. 1 is a flowchart of an information processing method according to an embodiment of the present disclosure. The method includes the following steps.

S11: Receive a first document, so as to perform preset processing on the first document.

S12: Determine, based on document content of the first document, or the document content and associated information of the first document, whether there is an alert item in the first document that satisfies a preset condition.

S13: Display the first document in association with the alert item in response to there being the alert item in the first document.

In some embodiments, the first document may be an online document, an offline document, or a local document. The first document may be any type of document, or a preset type of document. The method provided in this embodiment of the present disclosure may be performed by a terminal or a server to identify content in the first document and determine whether there is an alert item in the first document. In some embodiments, the first document is subjected to preset processing after being received. The preset processing may be, for example, collaborative creation of the document, or collaborative review of the document content, etc. In some embodiments, the document content of the first document may include text, a picture, a table, etc., which is not limited. The first document may have associated information. The associated information is information that has established an association relationship with the first document in advance. The associated information may be, for example, information about a processing flow of the first document, information about a collaborating user of the first document, information about a user to whom the first document is attributed, etc., which is not limited. In some embodiments, one or more preset conditions may be set. Aler items may be classified into different categories. One preset condition may correspond to one category of alert items. For example, different categories of alert items may be set in advance, and then different preset conditions may be set for different categories of alert items. The alert items are important content in the first document, which may be, for example, risk items in the first document. The risk items may be, for example, content with potential risks. For example, the alert items may include content with errors in the first document, content that needs to be verified, and content that is inconsistent with a reference document, etc. The alert items may include, for example: important items such as a participant name, a transaction amount, and a transfer account. The alert items may display category information, which may be used to indicate a category of content suggested by the alert items. For example, the alert items suggest a party inconsistency or a case inconsistency in the first document. Here, the “party inconsistency” and the “case inconsistency” may be category information. The alert item may be displayed in the form of a card, and the category information may be used as a title of the alert item. In some embodiments, the first document is displayed in association with the alert item, and the first document has established an association relationship with the alert item. For example, when a control identifier (such as a mouse) is located on content corresponding to the alert item in the first document, a display style of the alert item corresponding to the content may change. When the alert item is displayed in the form of the card, the card may be automatically opened. The alert item may be displayed in a first display area of a display interface, and the first document may be displayed in a second display area of the display interface. The first display area may be different from the second display area, or may be a part of the second display area. According to the method provided in this embodiment of the present disclosure, the alert item in the first document is identified and displayed in association with the first document, and the category information of the alert item is displayed, to effectively enable users to pay attention to important content in the first document and learn a category of the alert item, so as to facilitate the users in focusing on different categories of important content. This can ensure security, and can also enable the users to quickly find corresponding content through the alert item when the users particularly focus on some categories of information.

In some embodiments of the present disclosure, there is a first control in the display interface where the preset processing is performed on the first document, and the displaying the first document in association with the alert item in response to there being at least one alert item in the first document includes: in response to a first operation on the first control, if there is the alert item in the first document, displaying the first document in association with the alert item. In some embodiments, by performing the first operation on the first control, such as a click operation, the alert item may be displayed in the first display area, and by setting the first control, the alert item may be displayed only when the user wants to view the alert item, avoiding interference with the user. In some embodiments, it is determined whether there is an alert item in the first document only when the first document is in a preset document format. The preset document format may be an editable document format. In some embodiments, documents in different formats may be processed in different ways. For example, for an editable document, the alert item is displayed as comments, and for a non-editable document, the alert item is displayed in a region outside the document.

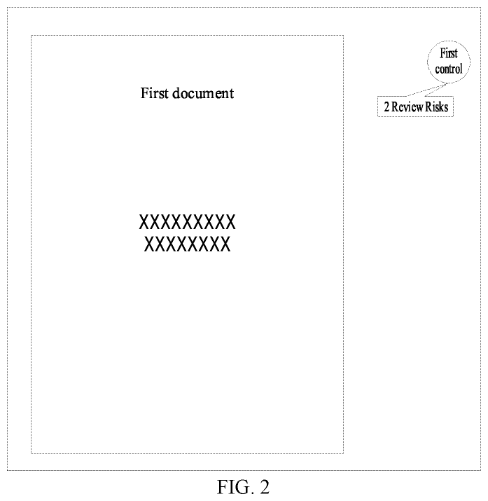

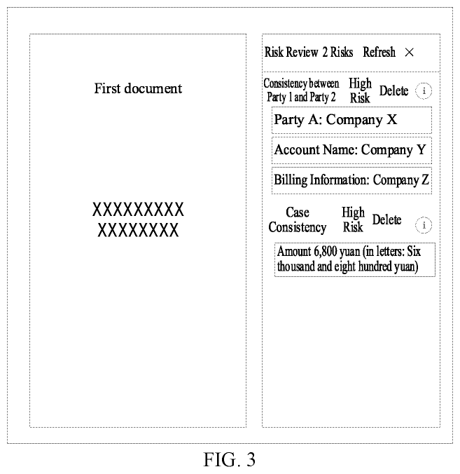

According to the method provided in this embodiment of the present disclosure, the alert item in the first document is identified and displayed to facilitate effective prevention of risks, thereby ensuring security. A specific embodiment is provided below. In some embodiments, referring to FIG. 2, FIG. 2 schematically shows a schematic diagram of a display interface. It can be seen therefrom that the first document is displayed in a second display area of the display interface, and the first control is further displayed in the display interface. The first operation is performed on the first control by, for example, clicking on the first control, to display a display interface as shown in FIG. 3, where alert items existing in the first document are displayed in a first display area (a right region in FIG. 3) of the display interface. In this embodiment, the first display area is different from the second display area, such that a user can view the alert items while viewing the first document, which improves security. In some embodiments, the second display area is a region for displaying the first document, in which region a control for editing the first document, a title of the first document, how many people are currently viewing the first document, and a current processing status of the first document may further be displayed. The alert items are displayed in the first display area, and a number of the alert items, category information of the alert items, and a risk level of the alert items may further be displayed in the first display area. The alert items may be expanded and collapsed. When the alert items are collapsed, only the category information and the risk level of the alert items may be displayed. When the alert items are expanded, document content with a risk in the first document is displayed. The first document and the alert items are displayed in different regions of the display interface, such that the display of the first alert item is not affected when the first document is flipped down or up, and in turn, the first document is not affected when the alert items are flipped, thus enabling easy comparison for the user. In some embodiments, the alert item is provided with an associated second control. After the second control (such as a button marked “Delete”) is triggered, the corresponding alert item is hidden, but part of the information of the hidden alert item is still displayed in the first display area, for example, the category information of the hidden alert item is displayed, such that the user can know which alert items are hidden, thereby preventing potential danger due to a subsequent mistaken assumption of the user that there is no such an alert item in the document.

In some embodiments of the present disclosure, the performing preset processing on the first document includes: performing the preset processing on the first document by at least two collaborating users; and the displaying the first document in association with the alert item in response to there being the alert item in the first document includes: displaying the first document in association with the alert item in display interfaces of processing flow collaborators (which may also be referred to as collaborating users) who perform the preset processing on the first document. In some embodiments, the first document is a collaborative document. The collaborative document may be an online document or an offline document. The first control is displayed in display interfaces of a creator of the first document and collaborators related to the processing flow of the first document. In some embodiments, with the first document being an online collaborative document as an example, collaborating users of the first document may log in to their respective accounts to view the first document, which may be, for example, a contract document, the user may upload the first document to a server, and the collaborating users can then log in to the server to view the first document, thus improving the efficiency of collaboration. The collaborating users may be users related to the processing flow of the preset processing of the first document, for example, an initiator of the processing flow of the preset processing of the first document or processing flow collaborators related to the processing flow. The processing flow collaborators may be persons at different process nodes of the processing flow, such as handlers of the process nodes. In some embodiments, the first document may be displayed in association with the alert item in display interfaces of the processing flow collaborators of the preset processing, which can facilitate the collaboration between different collaborating users to process the first document together. In some embodiments, when the first document is a contract, the processing flow of the preset processing may be an approval process for the contract. In some embodiments, the first document may have one or more processing flow collaborators, but not all of the processing flow collaborators may be able to view an alert item in the first document, and only collaborators related to the processing flow of the first document can view the alert item in the first document. For example, when the first document is a contract, only an approver involved in the approval process for the contract can view the alert item. This can ensure that the collaborators related to the processing flow of the first document can view the alert item for processing, and prevent collaborators unrelated to the processing flow of the first document from obtaining too much information, thus implementing permission control and fulfilling confidentiality requirements.

In some embodiments of the present disclosure, a user type includes a first-type user and a second-type user, the second-type user being attributed to the first-type user, and a user type of the processing flow collaborators (which may also be referred to as collaborating users) being the second-type user. Displaying the first document in association with the alert item in display interfaces of processing flow collaborators who perform the preset processing on the first document includes: determining a display policy for displaying the alert item in the display interfaces of the collaborators, based on whether a first-type user to whom the collaborators are attributed, a first-type user to whom a preset object is attributed, and a first-type user to whom the collaborator's creator is attributed belong to a same preset set of first-type users, where the preset object includes at least one of the following: a processing flow, a creator of the first document, or an initiator of the processing flow. In some embodiments, one or more second-type users may be attributed to the first-type user. For example, the first-type user may be a group user, and the second-type user may be an individual user under the group user. The processing flow may also be attributed to a first-type user, who may be, for example, a pre-specified first-type user. The first-type user to whom the processing flow is attributed may be a first-type user responsible for the processing flow. In some embodiments, the preset set of first-type users may be composed of one or more first-type users. When the processing flow collaborators and the preset object are attributed to a same or different preset sets of first-type users, different display policies can be used. For example, when the processing flow collaborators and the preset object are attributed to the same preset set of first-type users, the alert items that can be displayed can be the same. When the processing flow collaborators and the preset object are attributed to different preset sets of first-type users, the alert items that are displayed may be not exactly the same, or even not displayed at all. In this way, different users can be further distinguished by the first-type user to whom they are attributed, and the alert items can be displayed in a differentiated manner, thereby implementing differentiated management of permissions.

In some embodiments of the present disclosure, the determining a display policy for displaying the alert item in the display interfaces of the collaborators includes: if the processing flow collaborators and the preset object belong to the same preset set of first-type users, determining, according to a first preset rule, whether to display the alert item and/or which alert item to display when it is determined to display the alert item; or if the processing flow collaborators and the preset object belong to different preset sets of first-type users, determining, according to a second preset rule, whether to display the alert item and/or which alert item to display when it is determined to display the alert item, where the first preset rule is different from the second preset rule, and the preset object may be the processing flow of the first document, or the initiator or creator of the processing flow. In some embodiments, when the processing flow collaborators and the preset object are attributed to the same preset set of first-type users, the display interfaces of the processing flow collaborators may display the same alert item and the same first type of prompt information as those displayed in a display interface of the preset object. Certainly, they may also be not exactly the same at this point. The display interfaces of some processing flow collaborators may also not display the alert items, which may be determined based on permissions of the processing flow collaborators. When the collaborators and the preset object are attributed to different preset sets of first-type users, the display interfaces of the processing flow collaborators may not display the alert items; or the display interfaces of the processing flow collaborators may display a second type of prompt information and display alert items that are not exactly the same as those displayed in the display interface of the preset object. The second type of prompt information is different from the first type of prompt information. In this way, different display rules can be used for different processing flow collaborators, such that only alert items that the processing flow collaborators focus on or have permissions to are displayed, thereby implementing differentiated management of permissions.

In some embodiments, the preset set of first-type users may include one first-type user, in which case different rules are used in this embodiment to display the alert items based on whether the collaborators and the preset object are attributed to a same first-type user, such that an alert item that is displayed matches a first-type user to whom a user is attributed, because users that are attributed to different first-type users may focus on different content. For example, when there are a plurality of companies or departments, they may focus on different content.

In some embodiments of the present disclosure, the alert item is provided with an associated second control, and an associated alert item is hidden after the second control is triggered; and after a first collaborating user hides the alert item through the second control, the hidden alert item is still displayed in a display interface of a second collaborating user, along with a control for undoing the hiding, or a control for accepting the hiding and the control for undoing the hiding, where the first collaborating user is different from the second collaborating user. In some embodiments, the method provided in the present disclosure can be used in collaborative processing scenarios. During collaborative processing, a first user may consider that an alert item does not pose a risk, and then hide the alert item through the second control for the alert item, while the hidden alert item is still displayed in the display interface of the second collaborating user, such that the second collaborating user can confirm whether he/she accepts to hide the alert item. If he/she accepts to hide the alert item, the control for accepting the hiding can be triggered to hide the alert item in the display interface of the second collaborating user at the same time. If he/she does not accept to hide the alert item, the control for undoing the hiding is triggered to keep the display of the hidden alert item. In some other embodiments, if the second collaborating user triggers the control for undoing the hiding, based on permission information of the second collaborating user and the first collaborating user, the hiding of the alert item in a display interface of the first collaborating user is undone, or a request to undo the hiding of the alert item is sent to the first collaborating user. In some embodiments, if the second collaborating user triggers the control for undoing the hiding and a second user has a higher permission than the first collaborating user, the hiding of the alert item may also be undone in the display interface of the first collaborating user, and the prompt information may be displayed. If the second user has a lower permission than the first user, the display interface of the second user can display a creation interface of request for undoing the hiding of the alert item, in which creation interface of request a reason for undoing the hiding of the alert item can be entered, and then the second collaborating user can send the request to the first collaborating user. The display interface of the first collaborating user displays the request for undoing the hiding of the alert item from the second user, such that the first collaborating user decides whether to accept to undo the hiding of the alert item and then sends a result back to the second collaborating user. In this embodiment of the present disclosure, the method can be used in collaborative processing scenarios, such that different users can cooperate with each other to process the alert item, thereby improving the processing efficiency.

In some embodiments of the present disclosure, the alert item is provided with an associated second control, and an associated alert item is hidden after the second control is triggered, the hiding including: changing a display position or display style of the hidden alert item, to distinguish the hidden alert item from an unhidden alert item; and after a first collaborating user hides the alert item through the second control, displaying a control for undoing the hiding in a display interface of the first collaborating user. In some embodiments, after the second control is triggered, the display style of the associated alert item may be changed, for example, it may be grayed out, to be distinguished from display styles of other unhidden alert items, such that the user knows which alert items are hidden. In addition, only part of information of the hidden alert item may be displayed, for example, only the category information is displayed, not specific content, and the control for undoing the hiding may also be provided at the same time.

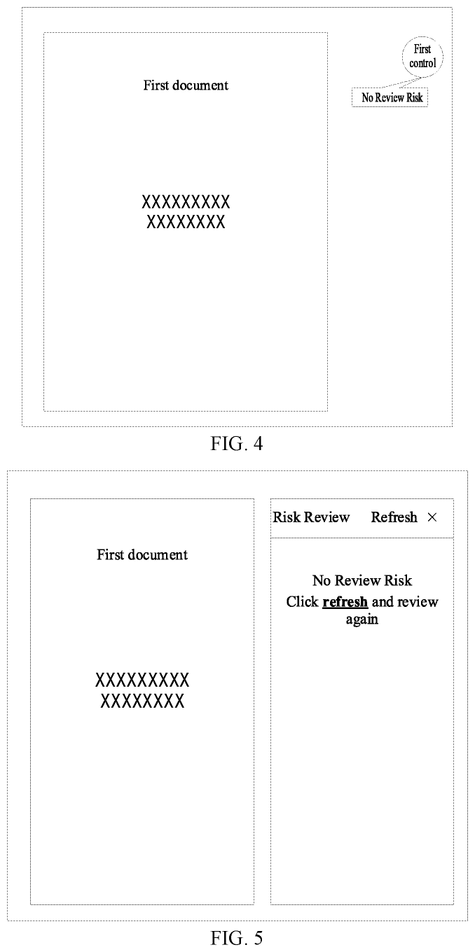

In some embodiments of the present disclosure, before responding to the first operation on the first control in the display interface, the method further includes: displaying, on the first control, first prompt information indicating whether there is an alert item. In some embodiments, as shown in FIG. 2, “2 review risks” may be displayed on the first control. In some embodiments, even if the first operation is not performed on the first control, the first prompt information is still displayed to remind the user of the alert item in the first document. In some other embodiments, when a control identifier (such as a displayed mouse) is hovering over the first control, the first prompt information is displayed. In some embodiments, as shown in FIG. 4, even when there is no alert item in the first document, the first prompt information is displayed to inform that there is no alert item in the first document. When there is no alert item in the first document, if the first control is triggered, as shown in FIG. 5, the first display area is still displayed to inform that there is no alert item in the first document.

In some embodiments of the present disclosure, before responding to the first operation on the first control in the display interface, the method further includes setting a display style of the first control based on whether there is an alert item in the first document, where a display style of the first control when there is an alert item in the first document is different from a display style of the first control when there is no alert item in the first document. In some embodiments of the present disclosure, in order to better prompt the user, the display style of the first control when there is an alert item in the first document is different from the display style of the first control when there is no alert item in the first document. For example, when there is an alert item, the first control is displayed in red, and when there is no alert item, the first control is displayed in green. In this way, the user may know whether there is an alert item in the first document without performing the first operation on the first control.

In some embodiments of the present disclosure, if the first document is collaboratively processed for the first time, the first prompt information is displayed. In some embodiments, the first prompt information is displayed only when the first document is collaboratively processed for the first time, and is automatically hidden thereafter to avoid interference with the user. Afterwards, the first prompt information is displayed when the control identifier is hovering over the first control. The control identifier may be a mouse, making it possible to know whether there is an alert item without opening the first display area.

In some embodiments of the present disclosure, after the first control is subjected to the first operation, the first control is hidden. As shown in FIG. 3, after the alert item is displayed, the first control is no longer displayed, thus preventing the user from performing the first operation on the first control again. In some embodiments, a risk level of the alert item is displayed in the first display area. As shown in FIG. 3, the right side of an alert item of “Consistency between Party 1 and Party 2” displays a risk level of “High Risk”, which gives an alert to the user to pay attention to the importance of different alert items. The risk level may include high risk, medium risk, and low risk. The risk level may also be displayed in other ways, such as in the form of level 1 and level 2.

In some embodiments of the present disclosure, the category information of the alert item is displayed in the alert item. In some embodiments, referring to FIG. 3, the category information in FIG. 3 is “Consistency between Party 1 and Party 2” and “Case Consistency”. In some embodiments, different category information is pre-stored. During determination of an alert item of the first document, semantic recognition is performed on content of the first document, so that whether there is an alert item that satisfies preset different category information is determined based on a result of the semantic recognition, and then an alert item that matches the result of the semantic recognition is used as the alert item of the first document.

In some embodiments, the alert item is arranged and displayed in a first display area according to a position order of content corresponding to the alert item in the first document. In some embodiments, the alert item corresponds to content in the first document. The user reads the first document from top to bottom. Therefore, the alert item is also arranged in order of content corresponding to the alert item in the first document, which is consistent with the order in which the user reads the first document, to facilitate viewing by the user.

In some embodiments, after the first document is displayed in association with the alert item, a jump is made, by default in the first document, to a position where content corresponding to the first alert item is located. In some embodiments, content corresponding to the first alert item is displayed in the first document. By default, the first alert item is first determined according to a preset order, and then the position of the content corresponding to the first alert item is displayed in the first document. In some embodiments, the alert item may display a plurality of pieces of document content, and a jump is first made by default to a position of the first of the plurality of pieces of document content. For example, in FIG. 3, there are two alert items, and a jump is first made, by default from top to bottom, to a position of content corresponding to the alert item of “Consistency between Party 1 and Party 2” in the first document. Since there are three pieces of document content in this alert item, a jump is first made by default to a position corresponding to document content of “Party A: Company X” in the first document. In some embodiments, when the control identifier (such as the mouse) is hovering over document content of an alert item, a display style of the document content in the alert item may be changed.

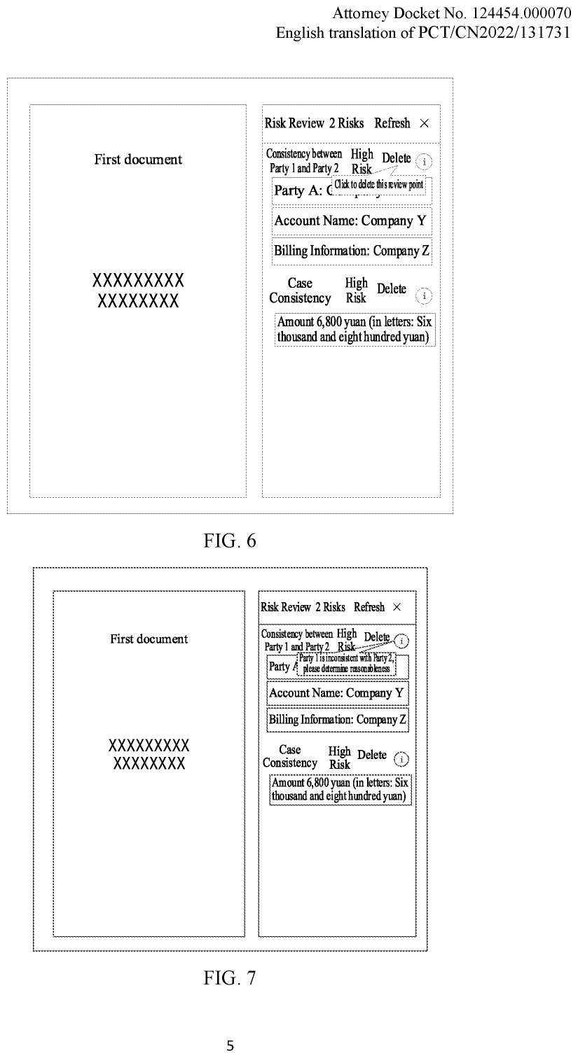

In some embodiments of the present disclosure, the method further includes: the alert item being provided with an associated second control, and an associated alert item being hidden after the second control is triggered. In some embodiments, the second control may be “Delete” displayed on the right side of an alert item shown in FIG. 6, and after the second control is triggered, a corresponding alert item is hidden.

In some embodiments of the present disclosure, the alert item is provided with an associated third control, the third control being configured to, after being subjected to a third operation, display second prompt information of the alert item associated with the third control. In some embodiments, as shown in FIG. 7, the third control may be a circle with an exclamation mark displayed therein on the right side of “Delete”. After the third control is subjected to a third operation such as clicking or hovering, the second prompt information is displayed, where the second prompt information may display at least one of a piece of prompt content of or a prompt reason for an associated alert item.

In some embodiments of the present disclosure, a fourth control is displayed, the fourth control being configured to, after being triggered, re-determine whether there is an alert item and display the alert item based on current content of the first document. In some embodiments, the fourth control may be “Refresh” shown in FIG. 6. After the fourth control is triggered, the content in the first document is re-identified, and it is determined whether there is an alert item, and an alert item is displayed based on a result. The fourth control is provided because the user may modify corresponding content in the first document after the alert item is displayed, such that the modified first document can be rechecked to determine whether there is an alert item. In some embodiments, if the first document is in a revision mode, after the fourth control is triggered, it is re-determined, based on modified document content, whether there is an alert item.

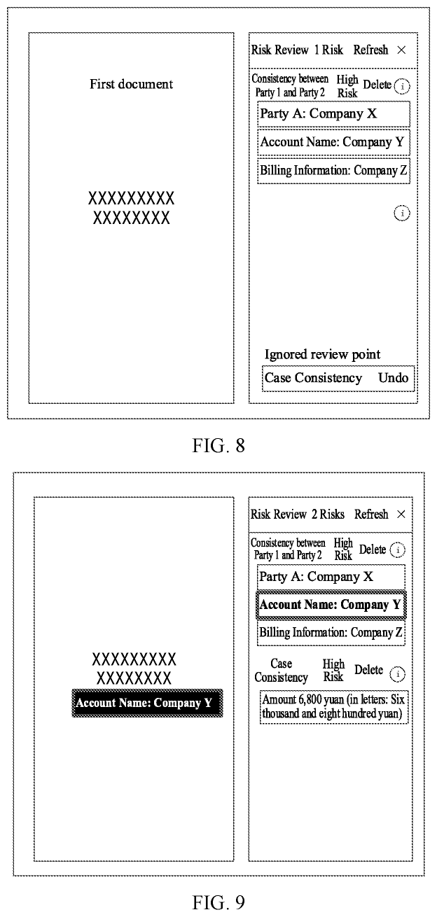

In some embodiments of the present disclosure, after the alert item is hidden, the hidden alert item and a fifth control are displayed in a target region, the fifth control being configured to undo the hiding of the alert item. In some embodiments, as shown in FIG. 8, after an alert item of “Case Consistency” is hidden, the hidden alert item is displayed in a target region (a lower right region in FIG. 8), along with a fifth control. The target region may be a sub-region of the first display area. The fifth control may be “Undo” displayed in the lower right of FIG. 8. After the fifth control is triggered, the hidden alert item of “Case Consistency” continues to be displayed in the first display area. When the control identifier is hovering over the fifth control, prompt information is displayed to prompt a function of the fifth control. In some embodiments, after the hiding of the alert item is undone, prompt information is displayed to inform that the undoing is successful.

In some embodiments, when the fourth control is triggered to re-determine whether there is an alert item and display the alert item, the hiding of the alert item that is hidden before the fourth control is triggered is kept. In some embodiments, as shown in FIG. 8, the alert item of “Case Consistency” is hidden. In this case, if the fourth control “Refresh” is clicked to re-identify an alert item in the first control, the alert item of “Case Consistency” continues to be hidden instead of being displayed, which avoids interference with the user. This is because after the user hides this alert item, it indicates that this alert item does not pose a risk.

In some embodiments of the present disclosure, after the alert item associated with the second control is hidden, the alert item associated with the second control is synchronously hidden in a display interface of a target collaborating user who is attributed to the same first-type user as a current collaborating user, where the target collaborating user is a creator of the first document or a collaborating user related to the processing flow of the first document. In some embodiments, the first document may be a collaborative document, and the first document may be collaboratively processed by a plurality of users. The current collaborating user may be the creator of the first document or the collaborator. After the current collaborating user hides a certain alert item, the target collaborating user is determined. The target collaborating user is attributed to the same first-type user as the current collaborating user, and is also a collaborating user of the current collaborating user, and this alert item will also be hidden from a display interface of the target collaborating user, instead of being displayed.

In some embodiments of the present disclosure, a number of alert items is displayed in a first display area, and after the alert item associated with the second control is hidden, the number of the alert items displayed in the first display area is changed. In some embodiments, reference is made to FIG. 7 and FIG. 8. In FIG. 7, “Risk Review 2 Risks” is displayed on the upper right. In FIG. 8, one of the alert items is hidden, and then “Risk Review 1 Risk” is displayed on the upper right of FIG. 8. The hidden alert item is excluded from alert items counted in the first display area, such that the user can clearly know how many alert items are still pending when they handle the alert items.

In some embodiments of the present disclosure, if the document content associated with the alert item displayed in the sub-region, or the document content and the associated information no longer satisfy the preset condition, third prompt information is displayed. In some embodiments, if the hidden alert item no longer satisfies the preset condition, the third prompt information may be displayed to inform the user about this. Specifically, the third prompt information may be displayed when the control identifier is hovering over the fifth control (“Undo” in FIG. 8). In some embodiments, the alert item no longer satisfying the preset condition may be determined based on the preset condition, or the collaborator or the creator of the first document may set the alert item as dissatisfying the preset condition.

In some embodiments of the present disclosure, the method further includes: in response to the alert item being triggered, jumping, in the first document, to a position where content corresponding to the triggered alert items is located. In some embodiments, the alert item may be triggered by clicking or other means, and after the alert item is triggered, a jump is made, in the first document, to a position where content corresponding to the alert item is located, to facilitate processing by the user. In some embodiments, there may be one or more pieces of document content in one alert item (for example, “Consistency between Party 1 and Party 2” in FIG. 6 has three pieces of document content). By triggering any piece of the document content, a jump may be made to corresponding document content in the first document.

In some embodiments, in response to the alert item being triggered, a display style of the content corresponding to the triggered alert item is changed in the first document. For example, the content corresponding to the alert item may be highlighted, such that the user can quickly determine the content corresponding to the alert item. Specifically, as shown in FIG. 9, the content corresponding to the triggered alert item will be highlighted in the first document. In this way, it can be known which alert item is currently being processed.

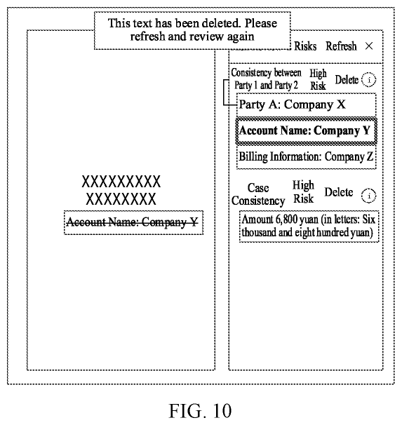

In some embodiments, in response to the alert item being triggered, if the content corresponding to the triggered alert item has been deleted from the first document, fourth prompt information is displayed. In some embodiments, the user may delete the content corresponding to the alert item from the first document. At this time, if the alert item is clicked, as shown in FIG. 10, the fourth prompt information is displayed to inform that the content has been deleted.

In some embodiments, in response to the alert item being triggered, if the content corresponding to the triggered alert item still exists in the first document, the triggered alert item is displayed in a first preset style, or if the content corresponding to the triggered alert item has been deleted from the first document, the triggered alert item is displayed in a second preset style, where the first preset style is different from the second preset style. In some embodiments, the display style of the alert item when the document content corresponding to the alert item has been deleted is different from the display style of the alert item when the document content corresponding to the alert item has not been deleted. By changing the display style of the alert item when the document content corresponding to the alert item is deleted, the user can be allowed to directly determine, based on the display style of the alert item, whether display content corresponding to the alert item has been deleted.

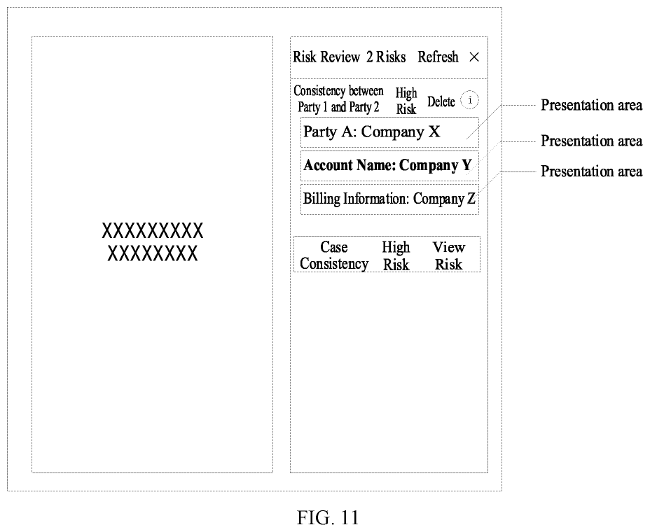

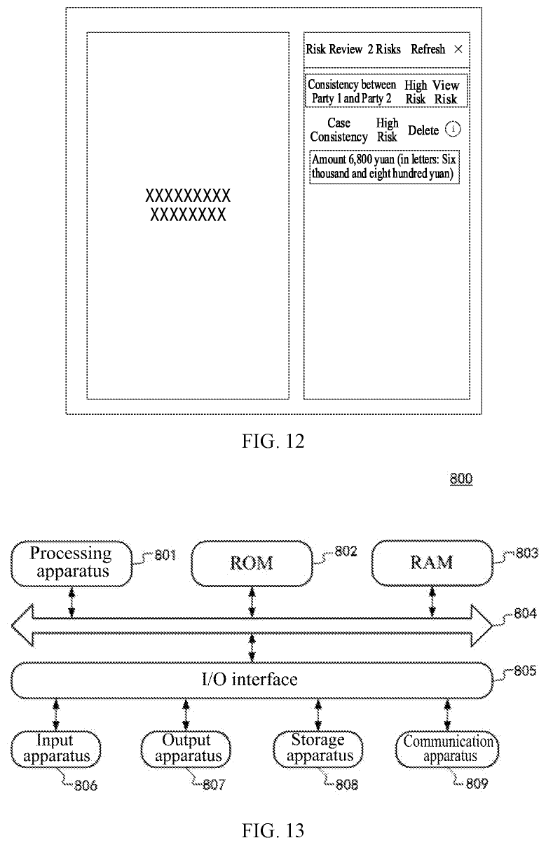

In some embodiments of the present disclosure, the displayed alert item is expandable and collapsible, and shortened information and detailed information of the alert item are displayed when the alert item is expanded, while the shortened information of the alert item is displayed and the detailed information of the alert item is hidden when the alert item is collapsed. In some embodiments, referring to FIG. 11 and FIG. 12, an alert item may be displayed in the form of a card, and has an expanded state and a collapsed state. In FIG. 11, an alert item of “Consistency between Party 1 and Party 2” is in the expanded state, and therefore, shortened information and detailed information of the alert item will be displayed, while an alert item of “Case Consistency” is in the collapsed state, and therefore, only shortened information of the alert item is displayed. In FIG. 11, an alert item of “Case Consistency” is in the expanded state, and therefore, shortened information and detailed information of the alert item are displayed. In some embodiments of the present disclosure, the shortened information includes: the category information of the alert item and the risk level of the alert item. Most important information should be displayed as much as possible when the alert item is collapsed. Therefore, in this embodiment, by displaying the category information, the user needs to be informed of what type of alert item exists and of the risk level of the alert item. In this way, the user is allowed to know whether the alert item needs to be processed immediately without having to expand the alert item. In some embodiments, the detailed information includes: document content corresponding to the alert item in the first document. In some embodiments, the document content corresponding to the alert item may be one or more of text, a table, a picture, etc. In some embodiments of the present disclosure, after the alert item is expanded, at least one presentation area is displayed in the alert item, the presentation area being used to display content corresponding to the alert item in the first document; and content displayed in different presentation areas is at different positions in the first document. In some embodiments, referring to FIG. 11, FIG. 11 shows the alert item of “Consistency between Party 1 and Party 2”, which is in an expanded state. This alert item presents three pieces of associated document content, and therefore, three presentation areas are displayed, with one piece of associated document content displayed in each of the presentation areas. Document content displayed in different presentation areas is at different positions in the first document, that is, the document content displayed in the three presentation areas is at discontinuous positions in the first document. In this way, the user can be informed of how much of the document content in the first document is related to the alert item through a number of presentation areas.

In some embodiments, in response to the first operation on the first control, the first alert item is expanded by default, and the remaining alert items are collapsed by default. In some embodiments, after the alert item in the first display area is triggered, the triggered alert item is expanded and the remaining alert items are collapsed in the first display area. In some embodiments, only one alert item is displayed at a time, which reduces the occupation of the first display area. In some embodiments, when the alert item is collapsed, a fifth control for expanding the alert item is displayed, and when the alert item is expanded, the fifth control is hidden. In some embodiments, as shown in FIG. 11 and FIG. 12, when the alert item is in the collapsed state, the fifth control of “View Risk” is displayed. By triggering the fifth control, the alert items is expanded. After the alert item is expanded, the fifth control is hidden, which avoids unresponsiveness to user's operations.

In some embodiments of the present disclosure, the method further includes: in response to re-receiving the first document, updating the displayed alert item based on the re-received first document. In some embodiments, the user may re-upload other versions of the first document. In this case, the re-uploaded first document is automatically detected for an alert item, and the displayed alert item is updated.

In some embodiments, a length of a name of an alert item may not exceed a preset length, otherwise the part that exceeds the preset length will be represented by an ellipsis, and a full name of the alert item is displayed when the control identifier is hovering over the name.

In some embodiments of the present disclosure, an information processing apparatus is further provided, the apparatus including:
a receiving unit configured to receive a first document, so as to perform preset processing on the first document;
a determination unit configured to determine, based on document content of the first document, or the document content and associated information of the first document, whether there is an alert item in the first document that satisfies a preset condition; and
a display unit configured to display the first document in association with the alert item in response to there being the alert item in the first document, where the alert item is displayed in association with category information.

In some embodiments, the display unit is further configured to display a first control in a display interface where the preset processing is performed on the first document; and
the displaying the first document in association with the alert item in response to there being the alert item in the first document includes: in response to a first operation on the first control, if there is the alert item in the first document, displaying the first document in association with the alert item.

In some embodiments, the performing preset processing on the first document includes: performing the preset processing on the first document by at least two collaborating users; and
the displaying the first document in association with the alert item in response to there being the alert item in the first document includes: displaying the first document in association with the alert item in display interfaces of the collaborating users who perform the preset processing on the first document.

In some embodiments, a user type includes a first-type user and a second-type user, the second-type user being attributed to the first-type user, and a user type of the collaborating users being the second-type user; and
the displaying the first document in association with the alert item in display interfaces of the collaborating users who perform the preset processing on the first document includes: determining a display policy for displaying the alert item in the display interfaces of the collaborating users, based on whether a first-type user to whom the collaborating users are attributed and a first-type user to whom a preset object is attributed belong to a same preset set of first-type users,
where the preset object includes at least one of the following: a processing flow, a creator of the first document, or an initiator of the processing flow.

In some embodiments, the determining a display policy for displaying the alert item in the display interfaces of the collaborating users includes:
if the collaborating users and the preset object belong to the same preset set of first-type users, determining, according to a first preset rule, whether to display the alert item and/or which alert item to display when it is determined to display the alert item; or
if the collaborating users and the preset object belong to different preset sets of first-type users, determining, according to a second preset rule, whether to display the alert item and/or which alert item to display when it is determined to display the alert item, where the first preset rule is different from the second preset rule.

In some embodiments, the preset set of first-type users includes one or at least two first-type users.

In some embodiments, the alert item is provided with an associated second control, and the display unit is configured to hide an associated alert item after the second control is triggered; and after a first collaborating user hides the alert item through the second control, the hidden alert item is still displayed in a display interface of a second collaborating user, along with a control for undoing the hiding, or the control for undoing the hiding and a control for accepting the hiding, where the first collaborating user is different from the second collaborating user.

In some embodiments, the display unit is further configured to, if the second collaborating user triggers the control for undoing the hiding, based on permission information of the second collaborating user and the first collaborating user, undo the hiding of the alert item in a display interface of the first collaborating user, or send a request to undo the hiding of the alert item to the first collaborating user.

In some embodiments, the alert item is provided with an associated second control, and an associated alert item is hidden after the second control is triggered, the hiding including: changing a display position or display style of the hidden alert item, to distinguish the hidden alert item from an unhidden alert item; and after a first collaborating user hides the alert item through the second control, displaying a control for undoing the hiding in a display interface of the first collaborating user.

In some embodiments, before responding to the first operation on the first control, the display unit is further configured to perform at least one of the following: displaying, on the first control, first prompt information indicating whether there is an alert item; or
setting a display style of the first control based on whether there is an alert item in the first document, where a display style of the first control when there is an alert item in the first document is different from a display style of the first control when there is no alert item in the first document.

In some embodiments, the display unit is further configured to display the first prompt information when the preset processing is performed on the first document for the first time.

In some embodiments, the display unit is further configured to display the first prompt information when a control identifier is hovering over the first control.

In some embodiments, the display unit is further configured to hide the first control after the first control is subjected to the first operation.

In some embodiments, a risk level of the alert item is displayed in the alert item.

In some embodiments, category information of the alert item is displayed in the alert item.

In some embodiments, the alert item is arranged and displayed in a first display area according to a position order of content corresponding to the alert item in the first document.

In some embodiments, after the first document is displayed in association with the alert item, a jump is made, by default in the first document, to a position where content corresponding to the first alert item is located.

In some embodiments, the alert item is provided with an associated second control, and an associated alert item is hidden after the second control is triggered.

In some embodiments, the alert item is provided with an associated third control, the third control being configured to, after being subjected to a third operation, display second prompt information of the alert item associated with the third control.

In some embodiments, a fourth control is displayed, the fourth control being configured to, after being triggered, re-determine whether there is an alert item and display the alert item based on current content of the first document.

In some embodiments, after the alert item is hidden, the hidden alert item and a fifth control are displayed in a target region, the fifth control being configured to undo the hiding of the alert item.

In some embodiments, when the fourth control is triggered to re-determine whether there is an alert item and display the alert item, the hiding of the alert item that is hidden before the fourth control is triggered is kept.

In some embodiments, after the alert item associated with the second control is hidden, the alert item associated with the second control is synchronously hidden in a display interface of a target collaborating user who is attributed to the same first-type user as a current collaborating user, where the target collaborating user is a collaborating user related to the processing flow of the first document.

In some embodiments, a number of alert items is displayed in a first display area, and after the alert item associated with the second control is hidden, the number of the alert items displayed in the first display area is changed.

In some embodiments, if the document content associated with the alert item displayed in the target region, or the document content and the associated information no longer satisfy the preset condition, third prompt information is displayed.

In some embodiments, the display unit is further configured to: in response to the alert item being triggered, perform at least one of the following:
jump, in the first document, to a position where content corresponding to the triggered alert item is located;
change, in the first document, a display style of the content corresponding to the triggered alert item;
if the content corresponding to the triggered alert item has been deleted from the first document, display fourth prompt information; or
if the content corresponding to the triggered alert item still exists in the first document, displaying the triggered alert item in a first preset style, or if the content corresponding to the triggered alert item has been deleted from the first document, display the triggered alert item in a second preset style, where the first preset style is different from the second preset style.

In some embodiments, the alert item is expandable and collapsible, and shortened information and detailed information of the alert item are displayed when the alert item is expanded, while the shortened information of the alert item is displayed and the detailed information of the alert item is hidden when the alert item is collapsed.

In some embodiments, the shortened information includes: the category information of the alert item and the risk level of the alert item; and/or the detailed information includes: document content corresponding to the alert item in the first document.

In some embodiments, after the alert item is expanded, at least one presentation area is displayed in the alert item, the presentation area being used to display content corresponding to the alert item in the first document; and content displayed in different presentation areas is at different positions in the first document.

In some embodiments, after the first document is displayed in association with the alert item, the first alert item is expanded by default, and the remaining alert items are collapsed by default;
In some embodiments, after the alert item is triggered, the triggered alert item is expanded and the remaining alert items are collapsed.

In some embodiments, when the alert item is collapsed, a fifth control for expanding the alert item is displayed, and when the alert item is expanded, the fifth control is hidden.

In some embodiments, the receiving unit is further configured to, in response to re-receiving the first document, update the displayed alert item based on the re-received first document.

The apparatus embodiment substantially corresponds to the method embodiment, and therefore, for related parts of the apparatus embodiment, reference may be made to part of the description of the method embodiment. The apparatus embodiment described above is merely illustrative. The modules illustrated as separate modules may be or may not be separate. Some or all of the modules may be selected according to actual requirements to achieve the objective of the solution of this embodiment. Those of ordinary skill in the art can understand and implement the embodiment without involving any creative effort.

The method and apparatus of the present disclosure have been described above based on the embodiments and application cases. In addition, the present disclosure further provides an electronic device and a computer-readable storage medium. The electronic device and the computer-readable storage medium are described below.

Referring to FIG. 13 below, there is shown a schematic diagram of a structure of an electronic device (such as a terminal device or a server) 800 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in the figure is merely an example, and shall not impose any limitation on the function and scope of use of the embodiments of the present disclosure.

The electronic device 800 may include a processing apparatus (e.g., a central processing unit, a graphics processing unit, etc.) 801 that may perform a variety of appropriate actions and processing in accordance with a program stored in a read-only memory (ROM) 802 or a program loaded from a storage apparatus 808 into a random-access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, a gyroscope, etc.; an output apparatus 807, for example, including a liquid crystal display (LCD), a speaker, a vibrator, etc.; a storage apparatus 808, for example, including a tape, a hard disk, etc.; and a communication apparatus 809. The communication apparatus 809 may allow the electronic device 800 to perform wireless or wired communication with other devices to exchange data. Although the figure shows the electronic device 800 having various apparatuses, it should be understood that it is not required to implement or have all of the shown apparatuses. Alternatively, more or fewer apparatuses may be implemented or provided.

In particular, according to an embodiment of the present disclosure, the process described above with reference to the flowcharts may be implemented as a computer software program. For example, the embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a Hypertext Transfer Protocol (HTTP), and can be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the method of the present disclosure described above.

The computer program codes for performing the operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination thereof. More specific examples of a machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, an information processing method is provided, the method including:
receiving a first document, so as to perform preset processing on the first document; determining, based on document content of the first document, or the document content and associated information of the first document, whether there is an alert item in the first document that satisfies a preset condition; and
displaying the first document in association with the alert item in response to there being the alert item in the first document, where the alert item is displayed in association with category information.

According to one or more embodiments of the present disclosure, an information processing method is provided, the method further including:
displaying a first control in a display interface where the preset processing is performed on the first document; and
the displaying the first document in association with the alert item in response to there being at least one alert item in the first document includes: in response to a first operation on the first control, if there is the alert item in the first document, displaying the first document in association with the alert item.

According to one or more embodiments of the present disclosure, an information processing method is provided, where the performing preset processing on the first document includes: performing the preset processing on the first document by at least two collaborating users; and
the displaying the first document in association with the alert item in response to there being the alert item in the first document includes:
displaying the first document in association with the alert item in display interfaces of processing flow collaborators who perform the preset processing on the first document.

According to one or more embodiments of the present disclosure, an information processing method is provided, where a user type includes a first-type user and a second-type user, the second-type user being attributed to the first-type user, and a user type of the collaborating users being the second-type user; and
the displaying the first document in association with the alert item in display interfaces of the collaborating users who perform the preset processing on the first document includes: determining a display policy for displaying the alert item in the display interfaces of the collaborators, based on whether a first-type user to whom the collaborators are attributed and a first-type user to whom a preset object is attributed belong to a same preset set of first-type users,
where the preset object includes at least one of the following: the processing flow, a creator of the first document, or an initiator of the processing flow.

According to one or more embodiments of the present disclosure, an information processing method is provided, where the determining a display policy for displaying the alert item in the display interfaces of the collaborating users includes:
if the collaborating users and the preset object belong to the same preset set of first-type users, determining, according to a first preset rule, whether to display the alert item and/or which alert item to display when it is determined to display the alert item; or
if the collaborating users and the preset object belong to different preset sets of first-type users, determining, according to a second preset rule, whether to display the alert item and/or which alert item to display when it is determined to display the alert item, where the first preset rule is different from the second preset rule.

According to one or more embodiments of the present disclosure, an information processing method is provided, where the preset set of first-type users includes one or at least two first-type users.

According to one or more embodiments of the present disclosure, an information processing method is provided, where the alert item is provided with an associated second control, and an associated alert item is hidden after the second control is triggered; and
after a first collaborating user hides the alert item through the second control, the hidden alert item is still displayed in a display interface of a second collaborating user, along with a control for undoing the hiding, or the control for undoing the hiding and a control for accepting the hiding,
where the first collaborating user is different from the second collaborating user.

According to one or more embodiments of the present disclosure, an information processing method is provided, where if the second collaborating user triggers the control for undoing the hiding, based on permission information of the second collaborating user and the first collaborating user, the hiding of the alert item in a display interface of the first collaborating user is undone, or a request to undo the hiding of the alert item is sent to the first collaborating user.

According to one or more embodiments of the present disclosure, an information processing method is provided, where the alert item is provided with an associated second control, and an associated alert item is hidden after the second control is triggered, the hiding including: changing a display position or display style of the hidden alert item, to distinguish the hidden alert item from an unhidden alert item; and after a first collaborating user hides the alert item through the second control, displaying a control for undoing the hiding in a display interface of the first collaborating user.

According to one or more embodiments of the present disclosure, an information processing method is provided, where before responding to the first operation on the first control, the method further includes at least one of the following:
displaying, on the first control, first prompt information indicating whether there is an alert item; or
setting a display style of the first control based on whether there is an alert item in the first document, where a display style of the first control when there is an alert item in the first document is different from a display style of the first control when there is no alert item in the first document.

According to one or more embodiments of the present disclosure, an information processing method is provided, the method further including at least one of the following:
displaying the first prompt information when the first document is collaboratively processed for the first time;
displaying the first prompt information when a control identifier is hovering over the first control; or
hiding the first control after the first control is subjected to the first operation.

According to one or more embodiments of the present disclosure, an information processing method is provided, the method further including at least one of the following: a risk level of the alert item being displayed in the alert item;
category information of the alert item being displayed in the alert item;
arranging and displaying the alert item in a first display area according to a position order of content corresponding to the alert item in the first document; or
after the first document is displayed in association with the alert item, jumping, by default in the first document, to a position where content corresponding to the first alert item is located.

According to one or more embodiments of the present disclosure, an information processing method is provided, the method further including at least one of the following: the alert item being provided with an associated second control, and an associated alert item being hidden after the second control is triggered;
the alert item being provided with an associated third control, the third control being configured to, after being subjected to a third operation, display second prompt information of the alert item associated with the third control; or
displaying a fourth control, the fourth control being configured to, after being triggered, re-determine whether there is an alert item and display the alert item based on current content of the first document.

According to one or more embodiments of the present disclosure, an information processing method is provided, the method further including at least one of the following: after the alert item is hidden, displaying the hidden alert item and a fifth control in a target region, the fifth control being configured to undo the hiding of the alert item; when the fourth control is triggered to re-determine whether there is an alert item and display the alert item, keeping the hiding of the alert item that is hidden before the fourth control is triggered;
after the alert item associated with the second control is hidden, synchronously hiding the alert item associated with the second control in a display interface of a target collaborating user who is attributed to the same first-type user as a current collaborating user, where the target collaborating user is a collaborating user related to the processing flow of the first document; or
displaying a number of alert items in a first display area, and after the alert item associated with the second control is hidden, changing the number of the alert items displayed in the first display area.

According to one or more embodiments of the present disclosure, an information processing method is provided, where if the document content associated with the alert item displayed in the target region, or the document content and the associated information no longer satisfy the preset condition, third prompt information is displayed.

According to one or more embodiments of the present disclosure, an information processing method is provided, the method further including: in response to the alert item being triggered, performing at least one of the following:
jumping, in the first document, to a position where content corresponding to the triggered alert item is located;
changing, in the first document, a display style of the content corresponding to the triggered alert item;
if the content corresponding to the triggered alert item has been deleted from the first document, displaying fourth prompt information; or
if the content corresponding to the triggered alert item still exists in the first document, displaying the triggered alert item in a first preset style, or if the content corresponding to the triggered alert item has been deleted from the first document, displaying the triggered alert item in a second preset style, where the first preset style is different from the second preset style.

According to one or more embodiments of the present disclosure, an information processing method is provided, where the alert item is expandable and collapsible, and shortened information and detailed information of the alert item are displayed when the alert item is expanded, while the shortened information of the alert item is displayed and the detailed information of the alert item is hidden when the alert item is collapsed.

According to one or more embodiments of the present disclosure, an information processing method is provided, where the shortened information includes: the category information of the alert item and the risk level of the alert item; and/or the detailed information includes: document content corresponding to the alert item in the first document.

According to one or more embodiments of the present disclosure, an information processing method is provided, where after the alert item is expanded, at least one presentation area is displayed in the alert item, the presentation area being used to display content corresponding to the alert item in the first document; and content displayed in different presentation areas is at different positions in the first document.

According to one or more embodiments of the present disclosure, an information processing method is provided, where at least one of the following is satisfied:
after the first document is displayed in association with the alert item, the first alert item is expanded by default, and the remaining alert items are collapsed by default;
after the alert item is triggered, the triggered alert item is expanded and the remaining alert items are collapsed; or
when the alert item is collapsed, a fifth control for expanding the alert item is displayed, and when the alert item is expanded, the fifth control is hidden.

According to one or more embodiments of the present disclosure, an information processing method is provided, the method further including:
in response to re-receiving the first document, updating the displayed alert item based on the re-received first document.

According to one or more embodiments of the present disclosure, an information processing apparatus is provided, the apparatus including:
a receiving unit configured to receive a first document, so as to perform preset processing on the first document;
a determination unit configured to determine, based on document content of the first document, or the document content and associated information of the first document, whether there is an alert item in the first document that satisfies a preset condition; and
a display unit configured to display the first document in association with the alert item in response to there being the alert item in the first document, where the alert item is displayed in association with category information.

According to one or more embodiments of the present disclosure, an electronic device is provided, the electronic device including:
at least one memory and at least one processor,
where the at least one memory is configured to store program code, and the at least one processor is configured to call the program code stored in the at least one memory to perform any one of the methods described above. According to one or more embodiments of the present disclosure, a computer-readable storage medium is provided, which is configured to store program code that, when executed by a processor, causes the processor to perform the method described above.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An information processing method, comprising:
receiving a first document, so as to perform preset processing on the first document;
determining, based on document content of the first document, or the document content and associated information of the first document, whether there is an alert item in the first document that satisfies a preset condition; and
displaying the first document in association with the alert item in response to there being the alert item in the first document, wherein the alert item is displayed in association with category information.

2. The method according to claim 1, wherein the method further comprises:
displaying a first control in a display interface where the preset processing is performed on the first document; and
the displaying the first document in association with the alert item in response to there being the alert item in the first document comprises: in response to a first operation on the first control, if there is the alert item in the first document, displaying the first document in association with the alert item.

3. The method according to claim 1, wherein the performing preset processing on the first document comprises: performing the preset processing on the first document by at least two collaborating users; and
the displaying the first document in association with the alert item in response to there being the alert item in the first document comprises:
displaying the first document in association with the alert item in display interfaces of the collaborating users who perform the preset processing on the first document.

4. The method according to claim 3, wherein
a user type comprises a first-type user and a second-type user, the second-type user being attributed to the first-type user, and a user type of the collaborating users being the second-type user; and
the displaying the first document in association with the alert item in display interfaces of the collaborating users who perform the preset processing on the first document comprises:
determining a display policy for displaying the alert item in the display interfaces of the collaborating users, based on whether a first-type user to whom the collaborating users are attributed and a first-type user to whom a preset object is attributed belong to a same preset set of first-type users,
wherein the preset object comprises at least one of the following: the processing flow, a creator of the first document, or an initiator of the processing flow.

5. The method according to claim 4, wherein the determining a display policy for displaying the alert item in the display interfaces of the collaborating users comprises:
if the collaborating users and the preset object belong to the same preset set of first-type users, determining, according to a first preset rule, whether to display the alert item and/or which alert item to display when it is determined to display the alert item: or
if the collaborating users and the preset object belong to different preset sets of first-type users, determining, according to a second preset rule, whether to display the alert item and/or which alert item to display when it is determined to display the alert item,
wherein the first preset rule is different from the second preset rule.

6. The method according to claim 4, wherein
the preset set of first-type users comprises one or at least two first-type users.

7. The method according to claim 1, wherein the alert item is provided with an associated second control, and an associated alert item is hidden after the second control is triggered; and
after a first collaborating user hides the alert item through the second control, the hidden alert item is still displayed in a display interface of a second collaborating user, along with a control for undoing the hiding, or the control for undoing the hiding and a control for accepting the hiding,
wherein the first collaborating user is different from the second collaborating user.

8. The method according to claim 7, wherein
if the second collaborating user triggers the control for undoing the hiding, based on permission information of the second collaborating user and the first collaborating user, the hiding of the alert item in a display interface of the first collaborating user is undone, or a request to undo the hiding of the alert item is sent to the first collaborating user.

9. The method according to claim 1, wherein the alert item is provided with an associated second control, and an associated alert item is hidden after the second control is triggered, the hiding comprising: changing a display position or display style of the hidden alert item, to distinguish the hidden alert item from an unhidden alert item; and
after a first collaborating user hides the alert item through the second control, displaying a control for undoing the hiding in a display interface of the first collaborating user.

10. The method according to claim 2, wherein before responding to the first operation on the first control, the method further comprises at least one of the following:
displaying, on the first control, first prompt information indicating whether there is an alert item; or
setting a display style of the first control based on whether there is an alert item in the first document, wherein a display style of the first control when there is an alert item in the first document is different from a display style of the first control when there is no alert item in the first document.

11. The method according to claim 10, wherein the method further comprises at least one of the following:
displaying the first prompt information when the preset processing is performed on the first document for the first time;
displaying the first prompt information when a control identifier is hovering over the first control; or
hiding the first control after the first control is subjected to the first operation.

12. The method according to claim 1, wherein the method further comprises at least one of the following:
a risk level of the alert item being displayed in the alert item;
category information of the alert item being displayed in the alert item;
arranging and displaying the alert item in a first display area according to a position order of content corresponding to the alert item in the first document;
after the first document is displayed in association with the alert item, displaying, by default in the first document, content corresponding to a first alert item;
the alert item being provided with an associated second control, and an associated alert item being hidden after the second control is triggered;
the alert item being provided with an associated third control, the third control being configured to, after being subjected to a third operation, display second prompt information of the alert item associated with the third control; or
displaying a fourth control, the fourth control being configured to, after being triggered, re-determine whether there is an alert item and display the alert item based on current content of the first document.

13. (canceled)

14. The method according to claim 12, wherein the method further comprises at least one of the following:
after the alert item is hidden, displaying the hidden alert item and a fifth control in a target region, the fifth control being configured to undo the hiding of the alert item;
when the fourth control is triggered to re-determine whether there is an alert item and display the alert item, keeping the hiding of the alert item that is hidden before the fourth control is triggered;
after the alert item associated with the second control is hidden, synchronously hiding the alert item associated with the second control in a display interface of a target collaborating user who is attributed to the same first-type user as a current collaborating user, wherein the target collaborating user is a collaborating user related to the processing flow of the first document; or
displaying a number of alert items in a first display area, and after the alert item associated with the second control is hidden, changing the number of the alert items displayed in the first display area.

15. The method according to claim 14, wherein
if the document content associated with the alert item displayed in the target region, or the document content and the associated information no longer satisfy the preset condition, third prompt information is displayed.

16. The method according to claim 1, wherein the method further comprises: in response to the alert item being triggered, performing at least one of the following:
displaying, in the first document, content corresponding to the triggered alert item;
changing, in the first document, a display style of the content corresponding to the triggered alert item;
if the content corresponding to the triggered alert item has been deleted from the first document, displaying fourth prompt information; or
if the content corresponding to the triggered alert item still exists in the first document, displaying the triggered alert item in a first preset style, or if the content corresponding to the triggered alert item has been deleted from the first document, displaying the triggered alert item in a second preset style, wherein the first preset style is different from the second preset style.

17. The method according to claim 1, wherein the alert item is expandable and collapsible, and shortened information and detailed information of the alert item are displayed when the alert item is expanded, while the shortened information of the alert item is displayed and the detailed information of the alert item is hidden when the alert item is collapsed.

18. The method according to claim 17, wherein at least one as follows is applied:
the shortened information comprises: the category information of the alert item and the risk level of the alert item; and/or the detailed information comprises: document content corresponding to the alert item in the first document;
or,
after the alert item is expanded, at least one presentation area is displayed in the alert item, the presentation area being used to display content corresponding to the alert item in the first document, and content displayed in different presentation areas is at different positions in the first document.

19. (canceled)

20. The method according to claim 17, wherein at least one of the following is satisfied:
after the first document is displayed in association with the alert item, a first alert item is expanded by default, and the remaining alert items are collapsed by default;
after the alert item is triggered, the triggered alert item is expanded and the remaining alert items are collapsed; or
when the alert item is collapsed, a fifth control for expanding the alert item is displayed, and when the alert item is expanded, the fifth control is hidden.

21. (canceled)

22. (canceled)

23. An electronic device, comprising:
at least one memory and at least one processor,
wherein the at least one memory is configured to store program code, and the at least one processor is configured to call the program code stored in the at least one memory to perform the method according to claim 1.

24. A computer-readable storage medium configured to store program code that, when executed by a processor, causes the processor to perform the method according to claim 1.
